(19) United States
(12) Patent Application Publication
(10) Pub. No.: US 2010/0171774 A1
(43) Pub. Date: Jul. 8, 2010

(54) DISPLAY DEVICE

(75) Inventors: Seiichi Mizukoshi, Kanagawa (JP); Makoto Kohno, Kanagawa (JP); Kouichi Onomura, Kanagawa (JP)

Correspondence Address: MCKENNA LONG & ALDRIDGE LLP, 1900 K STREET, NW, WASHINGTON, DC, 20006, US

(73) Assignee: GLOBAL OLED TECHNOLOGY LLC

(21) Appl. No.: 12/664,741

(22) PCT Filed: Jul. 17, 2008
(86) PCT No.: PCT/US08/08733

§ 371 Date: Dec. 15, 2009

(30) Foreign Application Priority Data
Jul. 23, 2007 (JP) 2007-193902

(51) Int. Cl. G06F 3/038; G09G 5/10

(52) U.S. Cl. 345/690; 345/211; 345/77

(57) ABSTRACT

A display device is disclosed having a plurality of pixels arranged in a matrix, in which a current driven light-emitting element is provided for each pixel, and current supplied to each light-emitting element is controlled based on input image data for each pixel for achieving display, the display device, includes a correction circuit for performing calculations based on the input image data and correction data, and correcting non-uniform luminance caused by variations in display characteristics for each pixel to produce correction data; a panel current detection circuit for detecting a panel current, which is the total current to be supplied to each pixel; and a modification circuit for modifying the correction data in response to a voltage drop due to the panel current to reduce errors in the correction data.

### FIELD OF THE INVENTION

The present invention relates to a display device in which a plurality of pixels are arranged in a matrix and a current driven light-emitting element is provided for each pixel, and which controls current supplied to each light-emitting element according to input image data for each pixel.

### BACKGROUND OF THE INVENTION

FIG. 1 shows an arrangement of a circuit of one pixel (pixel circuit) in a common active-matrix organic EL display device. FIG. 2 shows an arrangement of a display panel and input signals. Image data (image data signals) is sent to a shift register 12 in a source driver 10 in synchronization with a pixel clock, and transferred to a data latch 14 provided corresponding to each column of pixels, when one horizontal line of image data is taken into the shift register 12. Image data in the data latch 14 is then subject to D/A conversion at a D/A converter 16 and supplied to each data line 18. That is, one horizontal period of image data is simultaneously subject to D/A conversion and supplied to each data line 18 as analog voltage corresponding to display luminance. When a gate line (Gate) 22 extending in the horizontal direction for each column of pixel sections 20 is in at a high level, an n-channel selection TFT 2 is turned on, and data voltage on a data line (Data) 18 extending in the vertical direction is stored in a storage capacitor C. Thus, a p-channel drive TFT 1 supplies drive current corresponding to a data signal to an organic EL element 3, and then the organic EL element 3 emits light. Namely, current from a positive power source PVdd flows to a negative power source CV via the drive TFT 1 and the organic EL element 3. The gate line 22 is driven by a gate driver 24.

The amount of light emitted by the organic EL element 3 is substantially proportional to the drive current of the organic EL element. In general, a predetermined voltage (Vth) is applied between the gate and PVdd of the drive TFT 1, so that drain current begins to flow in the vicinity of the black level of an image. Furthermore, the amplitude of data voltage is supplied so that a predetermined luminance can be obtained in the vicinity of the white level.

FIG. 3 shows a relationship between data voltage (Vdata) of a drive TFT 1 and current (icy or luminance) flowing in an organic EL element. The gradation of the organic EL element can be appropriately adjusted by determining a data voltage such that voltage Vb can define a black level voltage and voltage Vw can define a white level voltage.

When a pixel is driven at a certain voltage, the current depends on the Vth of the drive TFT 1 and the gradient (μ) of a voltage-current (V-I) curve. As such, manufacturing defects or deterioration with age may cause undesirable changes in Vth or μ, leading to non-uniform luminance. In order to reduce non-uniform luminance, the data voltage applied to each pixel can be set such that the same input signals can provide the same luminance. To correct the non-uniform luminance, it has been suggested that Vth can be corrected by adding an appropriate value to signal data for driving each pixel (referred to as “offset correction”), or that μ can be corrected by multiplying by an appropriate value (referred to as “gain correction”) (See JP 11-282420 A, US 2004/0150592, and WO 2005/101360A1).

Here, there are cases in which a resistance is inserted into the PVdd line in order to reduce power consumption for high average luminance (See U.S. Pat. No. 6,870,322), or in which the influence of the resistance component in the PVdd line in a display panel cannot be ignored. Then, when the total current flowing through the panel becomes large, the voltage drop caused by the resistance component also becomes large, resulting in a small peak luminance. On the other hand, as the voltage drop of PVdd caused by the resistance in the PVdd line of the panel is not considered when determining correction values for non-uniform luminance, the correction precision decreases along with the increase of current flowing through the panel. That is, an image in which the overall luminance is high is displayed with imperfect correction of non-uniform luminance.

The present invention provides more accurate correction of non-uniform luminance among display elements.

### SUMMARY OF THE INVENTION

A display device is disclosed having a plurality of pixels arranged in a matrix, in which a current driven light-emitting element is provided for each pixel, and current supplied to each light-emitting element is controlled based on input image data for each pixel for achieving display, the display device, comprising:

(a) a correction circuit for performing calculations based on the input image data and correction data, and correcting non-uniform luminance caused by variations in display characteristics for each pixel to produce correction data;

(b) a panel current detection circuit for detecting a panel current, which is the total current to be supplied to each pixel; and

(c) a modification circuit for modifying the correction data in response to a voltage drop due to the panel current to reduce errors in the correction data.

Further, it is preferable that the modification circuit generates voltage drop values corresponding to the detected panel current, and calculates correction data based on pixel current drop values generated from the voltage drop values.

In addition, it is preferable that the panel current detection circuit calculates a panel current based on the input image data.

Additionally, it is preferable that the panel current detection circuit estimates a panel current from the input image data, and further calculates a panel current by taking into consideration current reduction caused by voltage drop at the resistance.

Still further, it is preferable that the panel current detection circuit detects the actual panel current.

Moreover, it is preferable that the light-emitting element is an organic EL element.

With the present invention, more accurate correction of non-uniform luminance appearing among display elements can be achieved because voltage drops at a resistance component in the power source line are taken into consideration.

### BRIEF DESCRIPTION OF THE DRAWINGS

FIG. 1 is a diagram showing an example arrangement of a prior art pixel circuit;

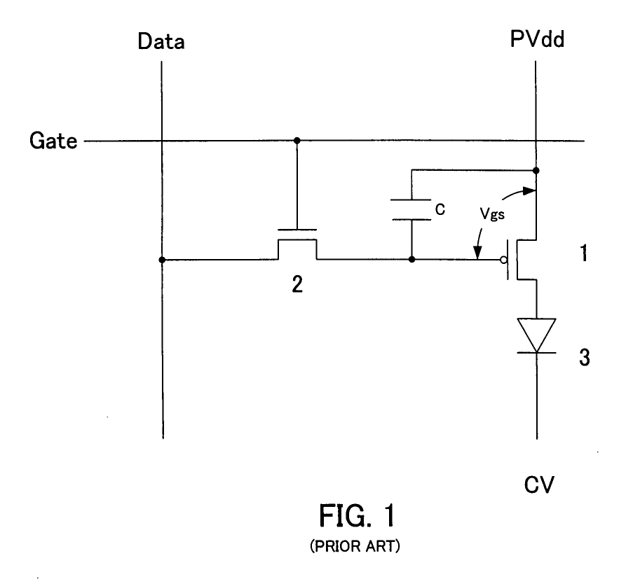

FIG. 2 is a diagram showing an overall arrangement of a display device in a related art;

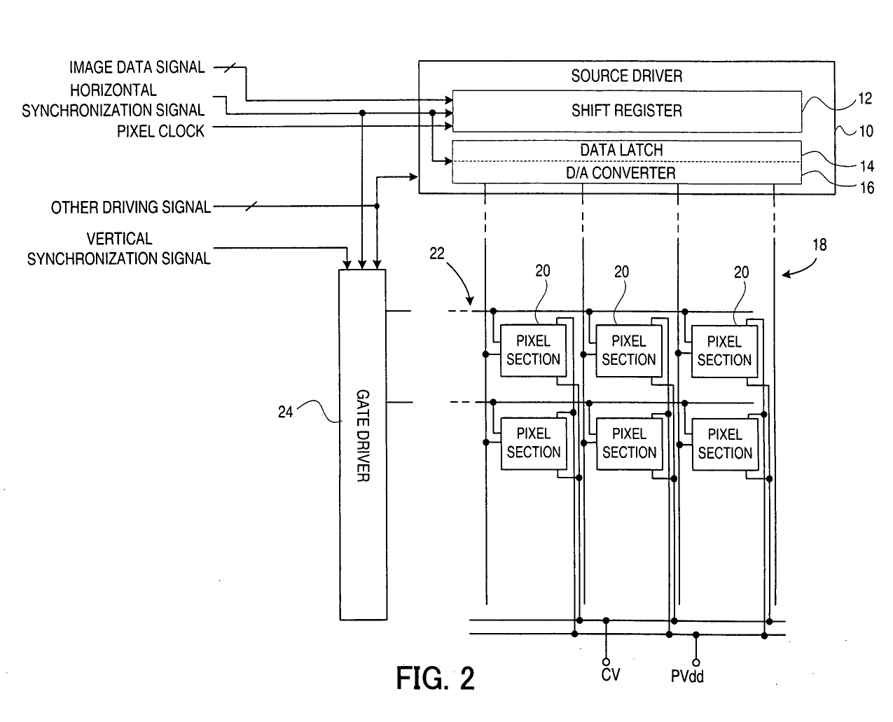

FIG. 3 is a diagram showing a relationship between voltage and luminance in the pixel circuit of FIG. 1;

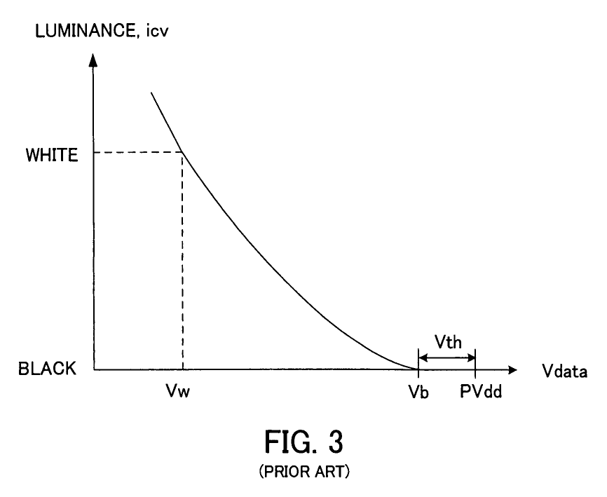

FIG. 4 is a diagram showing V-I characteristics of TFTs, and correction offset and correction gain according to the present invention;

FIG. 5 is a diagram showing an example arrangement of image data correction according to the present invention;

FIG. 6 is a diagram showing effects of voltage drop caused by a resistance r in the power source line on signal voltage and luminance according to the present invention;

FIG. 7 is a diagram showing an example arrangement with a resistance in the power source line according to the present invention;

FIG. 8 is a diagram showing effects on a panel current and a peak luminance in an arrangement with a resistance in the power source line according to the present invention;

FIG. 9 is a diagram showing an example arrangement for compensating for a resistance according to the present invention;

FIG. 10 is a diagram showing another example arrangement for compensating for a resistance according to the present invention;

FIG. 11 is a diagram showing yet another example arrangement for compensating for a resistance according to the present invention; and

FIG. 12 is a diagram showing an example of an input/output characteristic of ILUT according to the present invention.

### DETAILED DESCRIPTION OF THE INVENTION

Preferred embodiments of the present invention will be described below in detail with reference to the drawings.

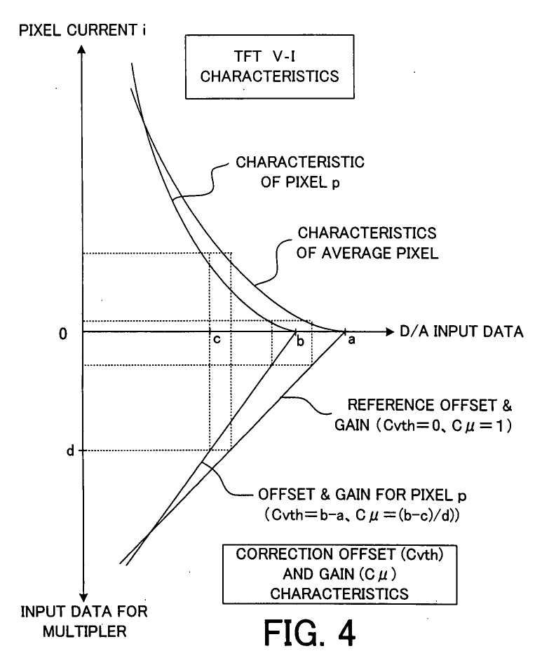

Examples of TFT V-I characteristics are depicted in FIG. 4. As shown in the upper part of the drawing, current flowing through pixels corresponding to image data (input data) which is input to a D/A converter depends on the characteristics of drive TFTs of the pixels. For average pixels, the reference relationship between pixel data and D/A input data is determined such that input data a represents the black level and a pixel current i corresponding to the white level input data becomes a predetermined value. This reference line satisfies the relationships Cvth=0 for offset and Cμ=1 for gain. On the other hand, the black level for a pixel p is set at point b. The D/A input data for an input data (multiplier input data) d prior to gain correction and offset correction should be set at point c in order to obtain the same pixel current as that for average pixels. Therefore, the pixel p satisfies the relationships Cvth=b−a for offset and Cμ=(b−c)/d for gain.

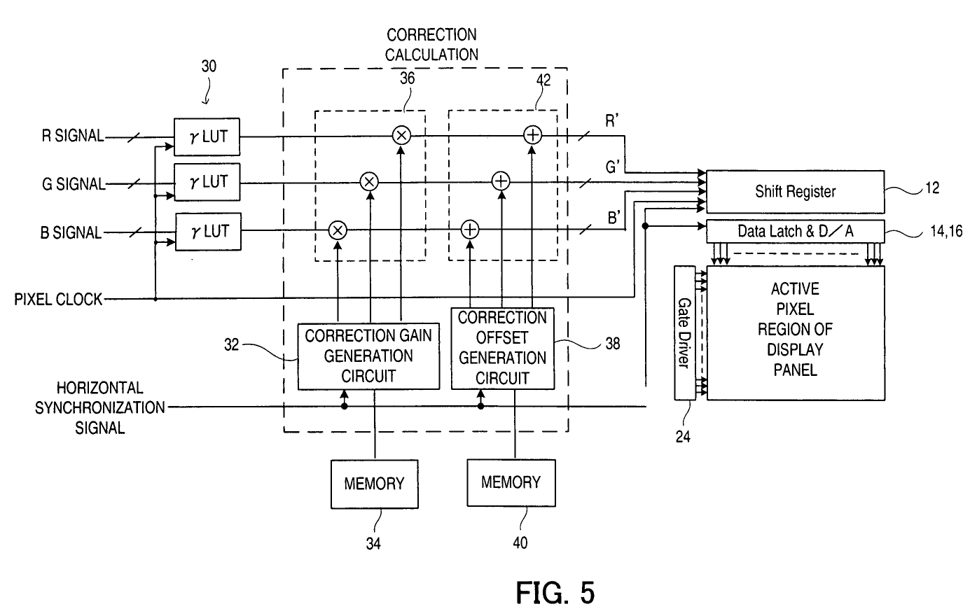

FIG. 5 shows an arrangement of a circuit for correcting input data for each pixel according to the characteristics shown in FIG. 4. Image data signals (R signals, G signals, and B signals) for each pixel are separately input into the respective γLUTs 30 for γ correction. A correction gain generation circuit 32 supplies a gain for each pixel as shown in FIG. 4, which is stored in a memory 34, to three multipliers 36, respectively. A correction offset generation circuit 38 supplies an offset for each pixel as shown in FIG. 4, which is stored in a memory 40, to a respective one of the three adders 42. Then, the outputs from the three γLUTs are subject to correction using the offset and gain, and the corrected image data (input data) is input into a shift register 12.

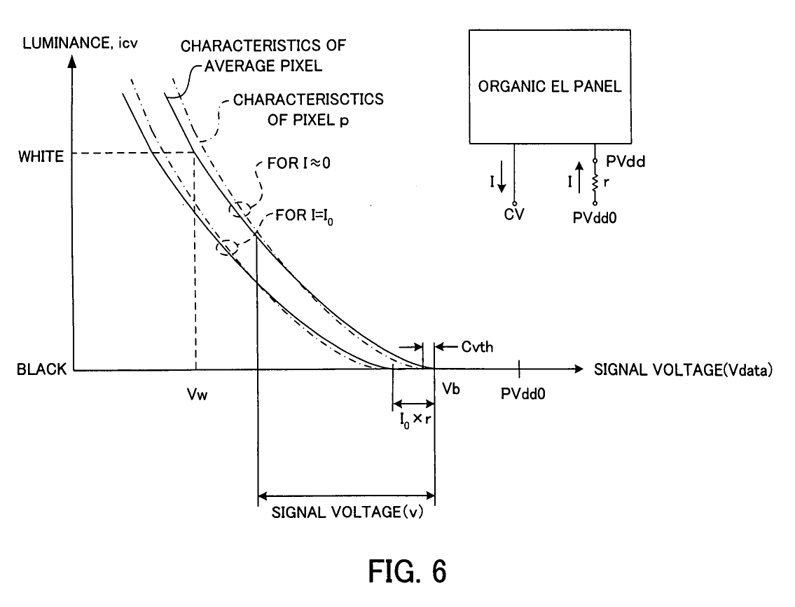

Here, an example is considered in which a resistance is inserted between the panel power source PVdd and the actual power source PVdd₀, as shown in FIG. 6. When the total current I of the panel (panel current) flowing through the resistance r is I₀, the PVdd voltage is reduced by I₀×r compared to the case where I is almost equal to zero. Thus, the signal voltage (Vdata) at which current starts flowing through the pixels is also reduced by I₀×r.

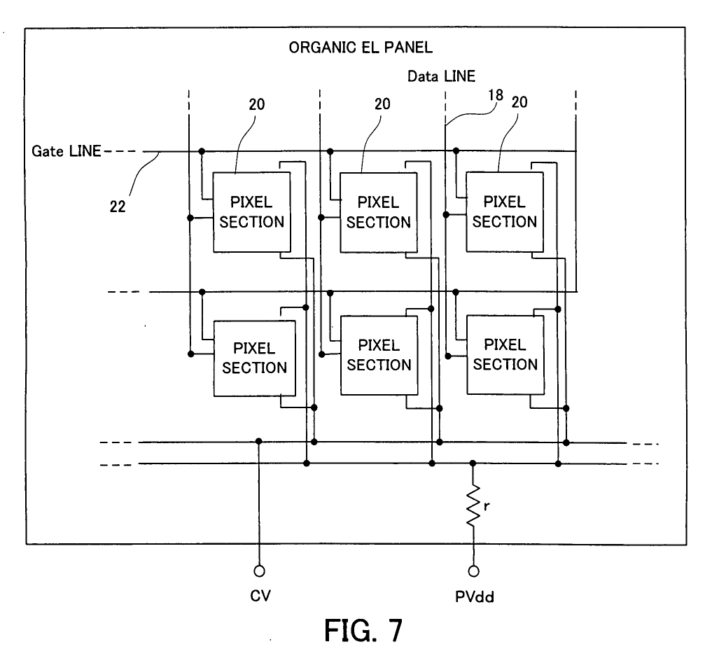

The described results are also obtained when a resistance component r is disposed in the power source line for supplying voltage from the power source PVdd of the panel to each pixel as shown in FIG. 7.

The resistance r as described above may reduce peak current because the total current of the panel cannot linearly increase as the total pixel data (the total panel current which should flow) becomes larger.

As a voltage drop due to such resistance component causes the same voltage shift for all pixels, non-uniform luminance does not appear even if the correction value for Vth (Cvth) is not changed. However, as the correction value for the characteristic μ of TFT (Cμ) assumes that the original black level is Vb, a correction shift will occur. To enhance correction accuracy, the term “−(Cμ−1)×I×r×k” should be added to obtain the formula below.

Hence, the corrected image data D′ may be expressed as follows:

D′=Cμ×D+Cvth−(Cμ−1)×I×r×k Formula 1

wherein D is signal output data of a γLUT, D′ is corrected signal data and input into a source driver, and k is a conversion gain of a D/A converter and given by the formula: k=(maximum data amplitude of D/A input)/(maximum voltage amplitude of D/A output).

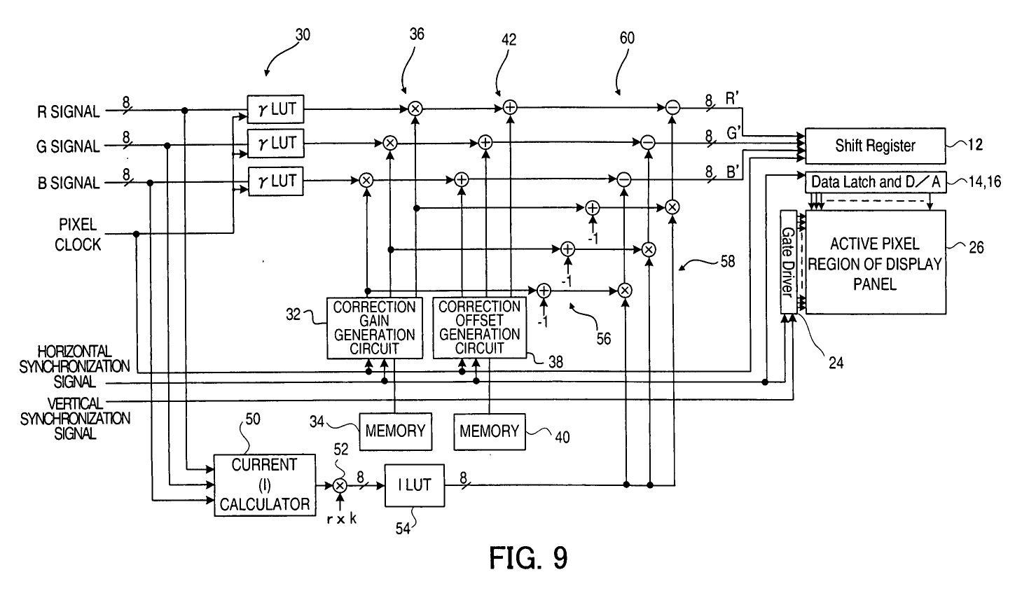

FIG. 9 shows an example of an arrangement of a circuit for fulfilling the above calculation. As shown in FIG. 9, R, G and B signals, which together represent RGB image data, are supplied to a current (I) calculator 50, which calculates a panel current. In this example, a current value is not the actual panel current, but a predicted panel current value determined based on calculations involving the image data.

In an active-matrix organic EL panel, data for each pixel is stored for one frame period in a storage capacitor which is added on the gate side of a drive TFT for driving pixels. If the influence of the resistance r is ignored, gamma correction for realizing proportionality between video signals and luminance, that is, an organic EL current shows proportionality between the total current of pixels in the organic EL panel at the completion of writing for one horizontal line and the total image data input during a period between one frame period before the completion and the completion. By calculating the proportionality constant beforehand, it is possible to estimate from the image data the total current of pixels per frame without the influence of the resistance r.

That is, the current (I) calculator 50 calculates the following value:

$$I ( t ) = {\sum }_{n = 0}^{{T}_{f} / {T}_{c}} ( \begin{matrix}R ( \begin{matrix}t - {T}_{f} + \\ n \times {T}_{c}\end{matrix} ) \times {A}_{r} + \\ G ( \begin{matrix}t - {T}_{f} + \\ n \times {T}_{c}\end{matrix} ) \times {A}_{g} + \\ B ( t - {T}_{f} + n \times {T}_{c} ) \times {A}_{b}\end{matrix} ) \qquad Mathematical Expression 1$$

wherein, R(t): R input signal level at time t

G(t): G input signal level at time t

B(t): B input signal level at time t

Aᵣ: (current flowing through one R pixel for maximum R input signal)/(maximum R input signal level)

A_{g}: (current flowing through one G pixel for maximum G input signal)/(maximum G input signal level)

A_{b}: (current flowing through one B pixel for maximum B input signal)/(maximum B input signal level)

T_{f}: one frame period

T_{c}: pixel clock period

The output from this current (I) calculator 50 is supplied to an adder 52, and multiplied by r×k, resulting in I(t)×r×k.

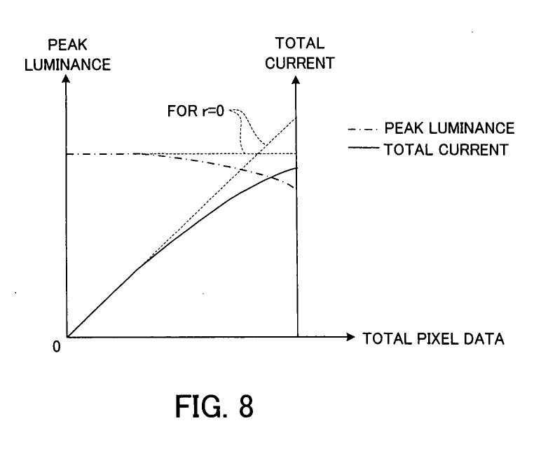

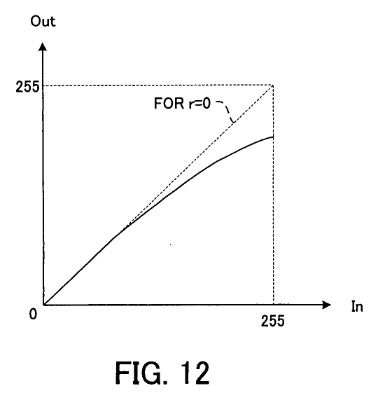

The resulting value for I(t)×r×k is supplied to an ILUT 54. As shown in FIG. 8, as the actual current flowing through the panel increases, the deviation from the proportionality between the current and the total pixel data becomes larger because the current is influenced by the resistance r. The ILUT 54 is a look-up table for correcting the deviation. For example, the ILUT 54 is created by plotting the relation between current calculation outputs and the actual panel current values using an image with uniform luminance. The ILUT 54 has a characteristic such that the output increases more slowly as input data becomes larger, as shown in FIG. 12. In the strict sense, the curve depends on the contents of an image. However, in general the contents do not have any significant influence on the correction results.

Then, in this look-up table ILUT 54, the predicted value of the total panel current which is calculated based on input image data is converted into the actual total panel current (or an approximate value), and the value for I×r×k is output.

The Cμ for each RGB signal which is output from the correction gain generation circuit 32 is incremented by −1 at one of the three adders 56 such that three values for Cμ−1 can be obtained. Each Cμ−1 is supplied to a respective one of three multipliers 58, where the input value is multiplied by I×r×k supplied by ILUT 54, resulting in (Cμ−1)×I×r×k for each RGB signal. Then, each (Cμ−1)×I×r×k is supplied to a respective one of three adders 60 as −(Cμ−1)×I×r×k. Each adder 60 adds −(Cμ−1)×I×r×k to Cμ×D+Cvth, which is obtained by multiplying the output D from the γLUT and Cμ supplied by the correction gain generation circuit and by adding Cvth supplied by the correction offset generation circuit, and obtains D′=Cμ×D+Cvth−(Cμ−1)×I×r×k for each RGB signal.

D′ is subsequently supplied to a D/A converter 16 via a shift register 12 and a data latch 14, and converted into analog data to be supplied to each data line. Thus, a data voltage for which the voltage drop caused by a resistance r in the power source line has been compensated can be obtained for each pixel, and uniformity of the display can be enhanced (non-uniform characteristics can be reduced).

The above-described correction expression can be transformed as follows:

D′=Cμ×D−(Cμ−1)×I×r×k+Cvth=D+(Cμ−1)×(D−I×r×k)+Cvth

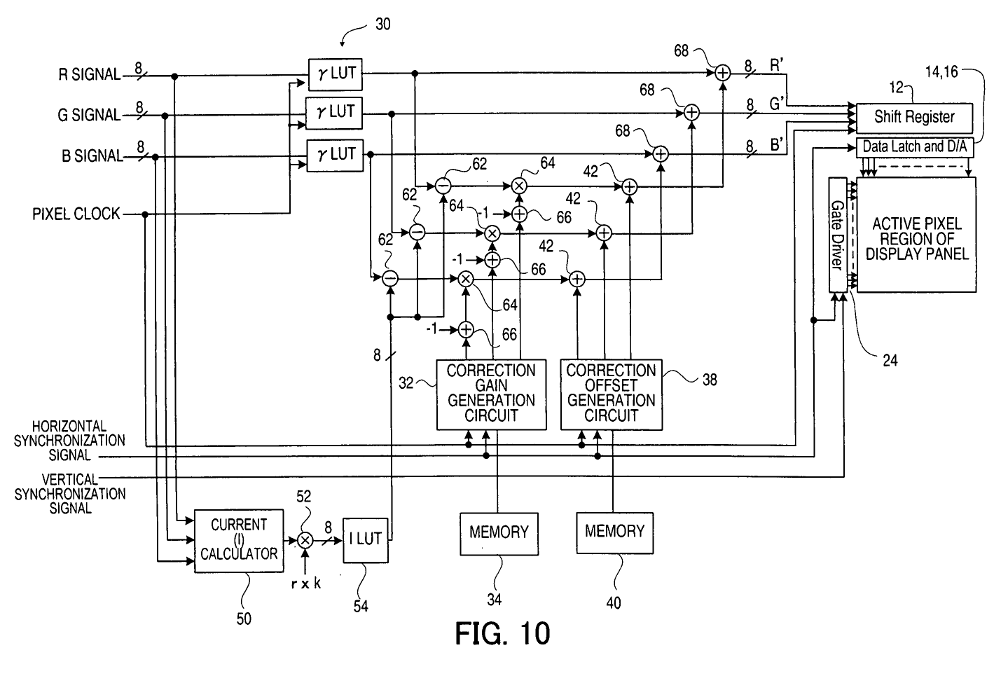

Therefore, an arrangement can be provided as shown in FIG. 10.

That is, each output D from each of the three γLUTs 30 is supplied to a respective one of the three adders 62, and from the input value is subtracted a value for I×r×k supplied by the ILUT 54, resulting in D−I×r×k. Next, each D−I×r×k is supplied to a respective one of the three multipliers 64, to be multiplied by (Cμ−1), which is obtained at each of the three adders 66 by subtracting 1 from Cμ supplied by the correction gain generation circuit 32, resulting in (Cμ−1)×(D−I×r×k). Then, each (Cμ−1)×(D−I×r×k) is supplied to a respective one of the three adders 42, at which Cvth supplied by the correction offset generation circuit 38 is added to (Cμ−1)×(D−I×r×k), resulting in (Cμ−1)×(D−I×r×k)+Cvth. Each (Cμ−1)×(D−I×r×k)+Cvth is added to D from each γLUT 30 at a respective one of the three adders 68, and then supplied to a shift register as D+(Cμ−1)×(D−I×r×k)+Cvth. There are three γLUTs, each of which is provided for one of the RGB signals as described above, and each output D is subject to the same process.

In this embodiment, as the number of adders can be smaller than that in the arrangement shown in FIG. 9, the circuit can be advantageously simplified.

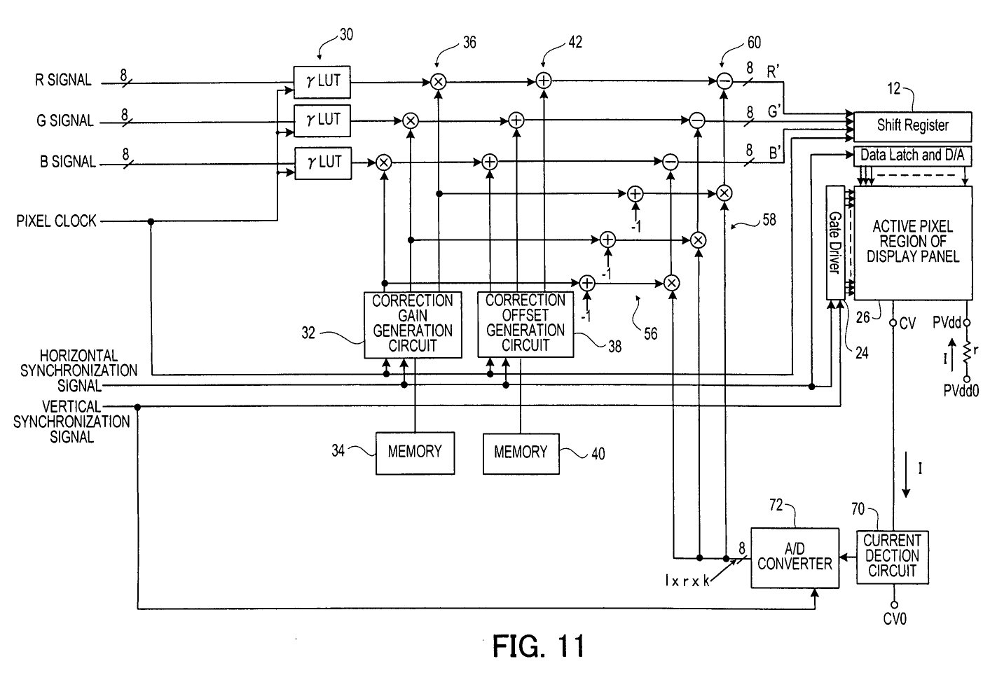

Also, an additional circuit can be provided for measuring the actual panel current flowing through the panel as shown in an arrangement in FIG. 11.

Here, a current detector 70 is provided between the low voltage side power source terminal CV provided for the panel and the actual low voltage side power source CV0. The output from the current detector is subject to A/D conversion at an A/D converter 72 to obtain a current value I. This current value I is multiplied by r×k, further multiplied by (Cμ−1) at a multiplier 58, and subtracted from D×Cμ+Cvth at an adder 60, resulting in D×Cμ+Cvth−(Cμ−1)×I×r×k.

Thus, as this arrangement considers the actual current flowing through the panel, accurate correction can be achieved. Further, even if the panel current varies from the initial state due to changes of environmental conditions such as ambient temperature or deterioration with age, accurate correction can be achieved in the arrangement shown in FIG. 11.

As described above, according to the present invention, non-uniform luminance can be accurately corrected, even if a resistance component is provided for the PVdd line.

### Parts List

1 TFT drive
2 TFT
3 organic EL element
10 source driver
12 shift register
14 latch
16 D/A converter
18 data line
20 pixel sections
22 gate line
24 gate driver
30 γLUTs
32 generation circuit
34 memory
36 multipliers
38 generation circuit
40 memory
42 adders
50 calculator
52 adder
54 ILUT
58 multipliers
60 adders
62 adders
64 multipliers
68 adders
70 current detector
72 A/D converter

1. A display device, having a plurality of pixels arranged in a matrix, in which a current driven light-emitting element is provided for each pixel, and current supplied to each light-emitting element is controlled based on input image data for each pixel for achieving display, the display device, comprising:
(a) a correction circuit for performing calculations based on the input image data and correction data, and correcting non-uniform luminance caused by variations in display characteristics for each pixel to produce correction data;
(b) a panel current detection circuit for detecting a panel current, which is the total current to be supplied to each pixel; and
(c) a modification circuit for modifying the correction data in response to a voltage drop due to the panel current to reduce errors in the correction data.

2. The display device according to claim 1, wherein the modification circuit generates a voltage drop value corresponding to the detected panel current, and calculates correction data based on a pixel current drop value generated from the voltage drop value.

3. The display device according to claim 1, wherein the panel current detection circuit calculates the panel current based on the input image data.

4. The display device according to claim 3, wherein the panel current detection circuit estimates the panel current from the input image data, and further calculates the panel current by taking into consideration a current reduction caused by a voltage drop at the resistance component.

5. The display device according to claim 1, wherein the panel current detection circuit detects the actual panel current.

6. The display device according to claim 1, wherein the light-emitting element is an organic EL element.
